(19) United States
(12) Patent Application Publication
(10) Pub. No.: US 2007/0022007 A1
(43) Pub. Date: Jan. 25, 2007

(54) System and method for a customer loyalty reward system utilizing a shopping search portal, a payment transfer agent and email marketing

(75) Inventor: Tabbatha Christie Lawe, Chapel Hill, NC (US)

Correspondence Address: ALUN L. PALMER, PATENT AGENT, 4300 PINEY CHURCH ROAD, WALDORF, MD, 20602, US

(73) Assignee: MyStoreCredit.com

(21) Appl. No.: 11/452,337

(22) Filed: Jun. 14, 2006

Related U.S. Application Data
(60) Provisional application No. 60/690,359, filed on Jun. 14, 2005.
(60) Provisional application No. 60/690,360, filed on Jun. 14, 2005.

(51) Int. Cl. G06Q 30/00

(52) U.S. Cl. 705/14; 705/26

(57) ABSTRACT

A seller registers with a loyalty reward program and provides access authorization for the seller's payment transaction information to a payment transfer agent, and receives HTML for displaying a reward offer to a buyer, which is presented in response to a browser accessing a selling page. Information from the selling page is captured and stored it in a database, and a portal page enables buyers to search for items offering a reward, ranking results by highest percentage reward, so items matching sellers with prior transactions with the buyer are placed higher. Periodically, the payment transfer agent is accessed to capture seller payment transaction information, to send a loyalty invitation email to the buyer. Invitation acceptance is recorded, and pending rewards are sent to the payment transfer agent for fulfillment. Repeat transactions are stimulated by sending marketing emails to the address used as an account identifier by the buyer.

This application claims priority from provisional application 60/690,359 and 60/690,360, both of which were filed on June 14^{th}, 2005, and both of which are hereby incorporated herein by reference.

### BACKGROUND OF THE INVENTION

1. Field of the Invention

This invention relates generally to systems and methods for rewarding buyers with rebates for purchases. This invention is for a loyalty system used by one or more sellers when a buyer searches a portal web site for items presented based upon the buyer's past purchases, and when an item is purchased by the buyer using the same payment transfer agent account used during the search. The invention also stimulates repeat transactions by creating and sending email promotions to the buyer's email address associated with the payment transfer agent account. This invention is particularly well suited for auctions or fixed price purchases executed at market venue web sites or via ecommerce web sites over networks including the Internet when payment has been made between a buyer and seller using an internet based payment transfer agent.

2. Background of the Invention

Customer loyalty programs involving rebates exist in many forms. These loyalty programs have the objective of attracting and retaining buyers for a seller under various economically efficient ways. A loyalty program can be uniquely designed and executed to best optimize the objectives of the seller while imposing appropriate major processes on the buyer all within the specific context of the buying/selling environment.

The most familiar loyalty programs are those of airlines. Airline frequent flyer programs demonstrate highly optimized loyalty programs for their unique environment. Sellers, in this case the airlines, have created a loyalty system which tracks airline miles and/or segments flown for buyers. Many airline loyalty programs also automatically calculate miles awarded based on prices paid. Buyers, in this case passengers, are provided with specific mileage hurdles to achieve a reward. The rewards are generally granted automatically by airline loyalty systems when a buyer reaches the mileage hurdle. A buyer only has to request her free tickets or class upgrades to receive them. Buyers are not required to mail in proof-of-flight (e.g. ticket stubs). Moreover, tracking of flights is automated by the airline loyalty systems. The combination of major processes for an airline loyalty system include establishing mileage hurdles, automating tracking of miles and incorporating an automated redemption process for valuable rewards. Such a loyalty system exemplifies the kind of process optimization within their environment which all loyalty programs seek to encompass. Optimization comes in the form of both increasing seller revenue through additional sales to the same buyer, while minimizing seller costs by implementing the loyalty program in an efficient manner using systems.

Failures of a loyalty programs can also be traced to a disconnect between the major processes of the loyalty program and the environment in which the loyalty program operates. In most cases, the engagement process for the buyer is to complex or the tracking of the rewards is to onerous or the reward process is too involved for the buyer to warrant participation.

To those not schooled in the art, the variety of loyalty programs can be thought of like different compositions of a “virtual fastener.” Each loyalty program is intended to bind a buyer and a seller together over time under specific environmental conditions defined by when, how, and why a buyer purchases with the same seller. In this “virtual fastener” analogy, those not schooled in the art can perhaps understand how unique loyalty programs can be invented to optimize binding a buyer to a seller in specific environments. For instance, one can easily understand that a specific glue chemical mixture can be created which is optimized to join different elements. Two pieces of a child's toy can efficiently be joined by a generic fastener, while an entirely different fastener would be required to efficiently join two parts on a space shuttle. These two different fasteners would naturally have entirely different properties and materials and each would clearly provide very different binding properties in the very different environments where they will bind two items. Likewise, as in the airline example above, loyalty systems can be designed an implemented using systems, software and reward mechanisms to optimize the binding of buyers and sellers within very specific environments.

One environment with an increasing need for effective loyalty between a buyer and a specific seller is retail selling on the Internet. The Internet selling environment is generally characterized by a relatively large number of sellers offering similar products to a geographically dispersed buyer base. The internet retail environment can also be described as commodity driven since the same item may be available from hundreds or even thousands of sellers at the same time. Since a buyer's sought-after item is often virtually identical between multiple sellers across the internet, the main differentiator for the sought-after item is price. Book sales on the Internet provide a concrete example of this internet retailing environment. A new best-selling book could be available from hundreds or thousands of book sellers on the internet at the same time. These sellers generally ship a book through the same shipping infrastructure (USPS, UPS or FedEx in the USA). Thus, in this environment, the book itself becomes a commodity item for retailing and shoppers can search across thousands of web-sellers in a matter of minutes using a search engine to find the lowest price for the book. Price becomes the primary differentiator.

An emerging characteristic for internet retailing is buyers will often being a search for sought-after items at a shopping search portal web site. Shopping search portal web sites will consolidate items for sale from different sellers at different web sites into one web site. Buyers can usually enter in the search terms for the items being sought anonymously and the shopping search portal web site will return the list of items in its database that match the buyer's search terms. Shopping search portal web sites provide the advantage to buyers of saving time by searching for items in one location. Shopping search portal web sites also offer the advantage to a seller of having the seller's item available for perusal by interested shoppers. Shopping search portal web sites return items in a standard order, but allow a buyer to re-order search results on various attributes such as item price, total price including shipping or seller rating scores. Unfortunately for each seller, the order does not take into consideration prior purchase transactions with the same buyer and seller. Results are usually not specifically ordered to see listings from sellers who the buyer has purchased from before. This is a disadvantage for the buyer because the buyer has a perceived higher risk when purchasing from an unknown seller. Likewise, prior transaction sellers are at a disadvantage in traditional shopping search portal web sites because they cannot capitalize on their prior purchase history with the searching buyer to differentiate themselves among in the item results. Sorting by seller rating scores is advantageous for a buyer because rating scores provide a measure of seller reputation as determined by other buyers. Whatever the experience of other buyers, first-hand experience with a seller is preferable for a buyer over rating scores determined by third parties.

Additionally, a buyer utilizing a traditional shopping search portal web site receives no reward benefit for prior purchases. One shopping search portal web site, shopping.com, offers a standard rebate on any purchase, but such rebate is not progressive with prior purchases and sellers are not ranked by a combination of prior purchases and higher progressively higher reward offers. Shopping.com's rebate offer does not provide for an efficient tracking and fulfillment of an offered reward to a buyer. Shopping.com claims rewards are issued via checks in the mail four times a year. This process, as mentioned elsewhere, is highly inefficient and contradictory to acceptable standards expected by web shoppers. Finally, shopping search portal web sites are passive promotion vehicles. Specifically, these search engines require a buyer to proactively come to the shopping search portal web site and enter search terms for the items sought. The traditional shopping search portal web site does not integrate email marketing into their operation and thus fail to generate additional sales for sellers and buyers who use the shopping search portal web site.

This Internet shopping environment can further be defined by the frequency a buyer shops with various sellers. Buyers might purchase from a seller for one book today, a second seller tomorrow for a different book, a third seller the next day for a third book and so on. This flexibility to shop across sellers is a benefit to the buyer, but also restricts the buyer's ability to gain efficiencies in pricing via discounts by committing to multiple purchases with one seller. Sellers will often offer a buyer lower prices across more than one purchase since the seller gets a higher total dollar profit across multiple sales versus a lower dollar profit across one sale. However, without a commitment or the knowledge that a buyer will return to make additional purchases, the seller will not offer discounts to the buyer. This creates an inefficient economic situation for both buyer and seller. Buyers want lower prices and might commit to multiple purchases to get even lower effective prices, but the seller is best served by only offering discounts if the seller is first assured of repeat purchases. Providing a progressive discount schedule for buyers based on future purchases allows for the efficiency sought by both buyer and seller. A seller can offer a buyer a progressive discount schedule where each subsequent purchase is offered a progressively deeper discount. However, the seller needs a system to track each subsequent purchase and a method and system to provide the progressive discount to the buyer in a cost efficient way. Moreover, the buyer needs to clearly understand the progression of the discount to properly assess whether a promised future discount will be valuable enough to purchase multiple items.

Moreover, in the internet retailing environment a seller may sell items on multiple different web sites across the internet. For instance, a seller may list items at eBay.com, Overstock.com, Amazon.com and on the seller's own e-commerce web site all at the same time. The seller is attempting to maximize his/her ability to reach the buyer at any of these web locations. Unfortunately, when a seller sells across multiple internet sites, he/she generally loses the ability to track and retain a buyer across these sites since buyers on different sites use different user-names. For instance, when registering for a site like eBay.com buyers are forced to create a pseudonym. On a seller's own web-site the buyer may simply register with their proper name. Internet retail sales are also characterized by the use of payment transfer services such as PayPal, GreenZap, BillPay and the others. These payment transfer services can often be used on different internet retail sites for purchases made by a single buyer. Thus, a buyer with various different registered names across many internet retail sites might still use one registered identifying name for all purchases when paying through a single payment transfer agent. This unique characterization of the internet retailing environment means that various different registered buyer names can often be tracked through a single payment transfer account. Likewise, a seller with multiple internet selling locations (e.g. eBay, Overstock, Amazon and their own e-commerce site) can track a single buyer making purchases from the seller on any of these sites for loyalty rewards by tracking the buyer's single payment transfer account identifier.

The internet retail environment is further defined by the fact that many buyers use different email addresses as a way to screen and categorize various possible inbound emails from web retailers. For instance, a buyer may have one email account for use at work which receives only work related emails. The same buyer may have a separate email which receives emails from family and friends. The same buyer may have several additional email accounts to receive emails relating to specific interests like college alumni emails, sports related emails, hobby-related emails etc. Some of these email addresses are more important to the buyer than others. The importance of an email address is often related to how frequently a buyer will check and review the email account for email communications. For instance, a work related email account might be reviewed by the buyer once an hour. Whereas an email account for a hobby or school might only be reviewed once per week. Because of the importance of the email account associated with a payment transfer agent, it can be assumed that the buyer will more frequently read and respond to emails sent to the buyer's payment transfer associated email address. This is an important consideration for sellers who wish to reach buyers with promotional emails within the context of a loyalty program. Sellers will be more successful if emails sent are reviewed with more frequency than other email accounts. It is therefore beneficial for a seller to reach a buyer in an email account with as high a priority as possible. By creating a loyalty program using the buyer's email account associated with the payment transfer agent, the seller has a significantly higher probability of getting the email read and acted upon.

In almost every payment option on the internet, the buyer provides the payment processor or payment transfer agent with the buyer's email address so the buyer can receive information from the payment processor or transfer agent relating to his/her account. In some instances, such as with PayPal, the buyer's email address is the payment transfer account identifier. The access and knowledge of the buyer's email address associated with the payment processor or transfer agent provides for a direct communication link to the buyer from the seller via email marketing.

Internet retailing is also defined by the opportunity to market to buyers via email promotions. Email marketing is a low cost method of promoting a seller's items to a buyer. Email marketing within the internet retail environment has evolved such that a seller is required by law or by common practice to request a buyer's permission to send emails to the buyer. This is known as opt-in permission. Generally, buyers provide opt-in permission at a very low rate, except in the case where the buyer is receiving some form of compensation for granting opt-in permission. MyStoreCredit.com claims that the industry average for opt-in permission without offering compensatory incentives averages 14%, while MyStoreCredit's Loyalty program offers a compensatory reward to buyers for granting opt-in permission through the form of a future store credit. MyStoreCredit claims it sees a 16.5% email opt-in rate when a reward is offered with the opt-in. Thus, providing some initial form of compensation to a buyer for opting-in to a seller's email marketing program has proven to be highly efficient.

The value of an email address is measured by the number of emails that can be sent to the buyer during the life of the loyalty service. If there is a “expiration” date for a reward in the loyalty program highlighted in each email, the value of the email address is only relevant until the expiration. Sending an email after a reward offer has expired would be an intrusion on the buyer.

Internet retailing can also be characterized by the speed and automation expected by buyers and sellers. This is important because in the internet retail context buyers will not tolerate being required to mail in coupons or having to wait long time periods for to receive promised loyalty benefits offered by internet retailers. In a traditional retail loyalty program, buyers often must mail in rebate forms or receipts. Buyers joining an internet loyalty program would expect to have automated processes such that the buyer does not have to be engaged in mailing forms or otherwise executing significant activities to receive his/her promised loyalty reward. The time expectations for rewards are also very different for an internet retailing model. Time expectations are measured through instant rewards versus accumulating rewards for traditional retail loyalty programs. This time element is critical to the internet retailing environment. A buyer in an internet retail environment has come to expect nearly instant response to their actions. For instance, they will not tolerate check-out procedures that take longer then a few seconds as evidenced by Amazon's one-click check-out procedure and patent. Thus, an internet retail loyalty program must also provide for nearly immediate rewards after purchase.

Finally, internet retailing can often be characterized by sellers who operate on low margins. Because of the price-driven environment explained earlier, the internet seller often operates on extremely low margins. eBay.com has published analysis which shows that items for sale on eBay are generally 30% below the price for similar items at other ecommerce sites. Overstock.com and Amazon.com both publicly inform investors that their strategies are to offer items at cut-rate prices. Such aggressive pricing limits gross margin dollars available to fund any overhead expense such as a loyalty program. Moreover, it is likely that the internet retailer, and especially the smaller internet retailers, will not have the financial resources to staff and operate his/her own loyalty program. Nor do these internet sellers have the financial resources to pay overhead or fixed expenses for a loyalty program. The seller's financial constraints favor a pay-for-performance driven and variable expense loyalty program.

Loyalty program optimized for the internet would be best implemented if it was variable cost driven and provides rewards commensurate with the spending made by the buyer. In this environment, it is critical that any loyalty program operate with a minimum of overhead expense, be primarily variable cost and require virtually no additional headcount or infrastructure to operate for an internet seller and be progressive so a seller incurs larger rewards only after additional buyer purchases. Such a loyalty program would also pay-out rewards and incur costs for the seller upon transactions executed by a buyer.

### OBJECTS AND ADVANTAGES

Accordingly, several objects and advantages of my invention are providing any number, or type, of internet sellers with a simple, readily understandable loyalty method and system for use when a buyer searches for items for sale by sellers on a shopping search portal web site with results displayed according to matching search terms and ranked by the loyalty reward percentage rebate being offered by said sellers. Buyers use the shopping search portal page after entering their payment transfer agent email ID and search terms. The email ID is utilized by the system for several advantages. First, the buyer email ID allows the system to track any seller item clicked-on by the buyer through to payment to that seller by the buyer. Subsequently, the system utilizes the email ID to provide the promised rebate to the buyer on behalf of the seller. Finally, the system uses the email ID to send buyers marketing emails promoting the seller's appropriate items.

Because of the association with the payment transfer account, the utilized email identifier account is likely to be a high-priority email account and thus any emails associated with the loyalty program will have a better chance of being read and responded to than if other email accounts are used for the buyer. Moreover, the optional use of progressive rewards for each subsequent purchase, versus a specific expiring reward, ensures that emails to the buyer will be valued as long as the seller offers the loyalty program. Rewards also benefit the seller during the search on the shopping search portal page because sellers with the most transactions with a buyer are shown earlier in the ordered search results. Early placement is advantageous to both buyers and sellers because buyers first see sellers from prior transactions, and sellers capitalize on their prior relationships with buyers before any other seller can compete for the buyer's attention.

The use of the payment transfer agent is central to the invention because it also allows for timely and efficient provision of loyalty rewards with low buyer engagement. Specifically, when a payment is made by the buyer using the payment transfer agent, the system can recognize and process the payment and associated transaction, determine the buyer's reward and process the reward as a rebate back through the same payment transfer agent account within a short time as expected for internet transactions. The loyalty program is designed such that all software and operations are centralized requiring only seller internet access. The system also operates independently of the seller's other software programs and will not require additional overhead expenses at the seller location. The elements of the loyalty program are designed to be a variable cost for the seller and rewards are progressive so sellers incur expenses commensurate with the buyer's transaction activity.

### SUMMARY OF THE INVENTION

A preferred embodiment of the present invention provides a system and method for enabling an auction or fixed-price seller, referred to herein as “seller,” to operate an online loyalty program for tracking and disbursing rewards to buyers paying for items with a payment transfer agent. The loyalty program also includes the creation and sending of email marketing messages to the buyer's email address associated with the payment transfer agent.

The loyalty system includes software and systems for a seller to establish her account within a seller database on the loyalty system using account creation software. Each time a seller establishes an account, the loyalty system also provides an authorization sequence to allow the seller to authorize the loyalty system to automatically access the seller's payment transfer agent account to retrieve transaction data. In a preferred embodiment of the invention, the authorization sequence includes the authorization for the loyalty system to automatically issue a buyer reward directly from the seller's payment transfer agent account.

Alternatively, during registration of a seller's account, the system can also provides for the seller to make a credit payment of a specified amount into a credit account. This credit account can be subsequently debited by the loyalty system for reward fulfillment to qualified buyers.

During registration, the seller is also asked to select the frequency of time for marketing emails to be sent to the seller's opted-in buyers. Frequency may be one or more choices.

During registration, the system also creates a unique image for the seller. The image is a computer graphic image used with the loyalty system by the seller to present the loyalty program to all potential buyers from within the seller's selling web page. The image discloses to potential buyers shopping for the seller's item, how the seller's loyalty program operates. Upon a buyer's browser opening the web selling page location where the seller desired the image to be presented, the buyer can readily view the loyalty image. In a preferred embodiment, the web selling page location is a seller's item selling page on a market venue such as eBay.com, Yahoo stores, Overstock.com or can also be a seller's item selling page on their own ecommerce store site. Alternatively, the web selling page can be presented as an HTML enabled email page within a web-enabled email reader.

Upon the first buyer viewing the HTML selling page where the seller desires to present the image, the loyalty system provides the image from its image server to the place on the page chosen by the seller.

The system next executes an item available to buy software routine to capture item selling information from the specific listing page location using the web page address or location as captured by the image server. The system captures the information on the web selling page and places it into an item available to buy database within the loyalty system. Alternatively, the system can periodically poll the seller's known item selling pages to capture the information and presence of the image. Upon capturing this data, the system holds enough information to recognize a seller has chosen to offer the loyalty program to the buyer concurrent with a specific item being sold by the seller at a specific web location and the system holds relevant data for that particular item.

Once the item available to buy information is captured, the system provides for the presentation of the item available to buy information on a shopping portal page. The shopping portal page presents any buyer using a web browser with forms for searching on a shopping portal page. When searching, the buyer may be required to enter in his/her email address as used on the payment transfer agent web site. The buyer also enters at least one search term and/or one category term to initiate a search. The shopping portal page software sends a database query using the search terms to the item's available to buy database to capture all items matching the buyer's entered search terms and/or category. The captured results of the query will include the information for each record from the item available to sell database including the title of the item and the seller offering the item.

Next, the shopping portal page software evaluates the buyer record for the buyer email id optionally entered to see if the buyer record includes any seller ID that matches the seller ID for the captured results. The system will present the items available to buy so that if the buyer has an existing history with a seller offering the sought-after item, that item will be shown first so that the buyer gets the highest rebate on the item. After all matching search term items have been ranked, the search results are presented to the buyer.

The buyer may click on any presented item title HTML link to view the actual HTML selling page of the item being sold. The combination in the shopping search results of the item sought along with the promise of a rebate reward first from prior sellers then from any seller, along with the inclusion of HTML links in the search results, such links associated with the available items for sale, acts as a powerful marketing message to stimulate buyer click-thru.

The shopping portal page software contains a routine which records each buyer click thru before redirecting the buyer's browser directly to the HTML selling page. Returning to the registration process, at the conclusion of the seller's registration the system creates HTML text which is associated with the seller's unique image. The HTML text is automatically sent to the seller via an email after the successful completion of the seller's registration. Alternatively, the system can automatically place the HTML text into the seller's item listing page or the seller can capture the HTML text off the loyalty reward system.

After registration is completed and the seller places the HTML code on any HTML selling page, the system presents the image from the system's image server so it can be viewed by a buyer's browser whenever the browser opens the collocated web selling page.

The loyalty system also includes a payment transfer agent account review software program which reviews the seller's payment transfer agent or payment processor account associated with the loyalty system at specific time intervals. If the payment transfer agent account review software recognizes a new payment transaction has occurred since the last review, the payment transfer agent review software captures the information and executes another software routine called the loyalty relevance evaluation software, to capture and evaluate the new transaction for loyalty program relevancy. Alternatively, the payment transfer agent can send notifications of received sale payment to the loyalty system

This loyalty relevancy evaluation software routine identifies the buyer ID in the newly captured payment transaction and determines if the buyer ID from the transaction exists in the loyalty buyer database along with the seller in the transaction. In a preferred embodiment, the buyer ID is a unique email address. If the system recognizes the buyer ID as already existing in the loyalty buyer database associated with the seller on the loyalty system, the system moves to execute a loyalty reward software routine for that buyer/seller transaction. If the system does not recognize the buyer ID associated with the seller in the transaction, the loyalty relevancy evaluation software moves to create a new record within the buyer database.

For each new record, the system next moves to automatically execute the loyalty invitation software routine for the qualified new buyer/seller combination. The loyalty invitation software routine creates and sends an email to the newly recorded buyer account offering the buyer enrollment into the new seller's loyalty program.

Upon receipt, a buyer opens and reads the invitation email and can accept the loyalty invitation offer by clicking an HTML link to acknowledge agreement to the rules and acceptance of the loyalty invitation. If the link is clicked, the email reader sends a standard message to the system which it records as the buyer's acceptance into the program. Optionally, a confirming email can be sent to the buyer notifying the buyer of the recorded buyer opt-in.

Once the buyer's acceptance is recorded, the buyer account is activated and is eligible for loyalty rewards and future marketing emails. The system's loyalty reward software routine is next initiated and executed for the eligible buyer account. The loyalty reward software routine evaluates the payment amount paid by the newly registered loyalty buyer and calculates a specific percentage rebate or currency figure for the price paid amount. In a preferred embodiment of the invention, the rebate reward percentage used for the first paid transaction of a loyalty buyer as recorded at the payment transfer agent is established by the seller during registration or may be updated by the seller at anytime after registration. The percentage will be applied to the payment amount to establish the reward due the loyalty buyer. The loyalty reward software routine will record the reward amount in the buyer database record. Next, the loyalty reward software routine will record relevant data about the buyer's rebate reward into a transaction specific record in an open mass pay file on the system's mass pay database.

In a preferred embodiment of the invention, an open mass pay file is created for each registered seller and holds all buyer rewards due from that seller to the seller's loyalty buyers. Alternatively, a single open mass pay file can be created which holds multiple buyer/seller transaction specific records for rewards due from each seller on the loyalty system to appropriately qualified buyers of the sellers. The system will continue to add individual transaction reward records to the mass pay file until a specified date and time, such as once per day at 12:00 am GMT. At that time, the mass pay software routine will close the existing mass pay file and open a new one for the next period. The mass pay software routine will maintain a copy of the closed mass pay file within the processed mass pay file database and will then send the closed mass pay file to the payment transfer agent using approved methods dictated by the payment transfer agent.

During execution of a the payment transfer agent account review software, if the system recognizes a payment from a prior buyer has occurred for the seller account being monitored the system will move to directly execute the loyalty reward software routine for the buyer account. The loyalty reward software routine evaluates the payment made by the prior loyalty buyer and calculates a specific percentage or dollar figure for the payment amount based on the sequence of the purchase. In a preferred embodiment of the invention, the rebate reward percentage calculated for the second transaction will be established by the seller during registration and can be modified anytime after registration.

The loyalty system periodically, such as once per day, executes a create marketing emails software program as part of its operation. Opt-in permission for sending email to a buyer is recorded by the system upon receiving the signal from the buyer's click in the invitation email when a buyer accepts the rules presented in the loyalty invitation email. On a daily basis the outbound email system will evaluate if the opted-in buyer is due a marketing email based on the frequency of emails identified during seller registration. When the create marketing emails software executes, it will capture email addresses for buyers due for an outbound email in the upcoming period.

To prepare the buyer's outbound email, the create marketing emails software on the system will compare the seller's current items available to sell, as recorded within the items available to sell database, and match those to the prior item or items purchased by the buyer as noted in the buyer database. The create marketing emails software attempts to match items to sell to the prior purchase according to key word and category matches. For instance, if the buyer has a prior purchase of a Golf club, the software will attempt to match seller items in the item available to sell database that have the words “golf” or “club”. In addition, the system will evaluate any category identifier for the prior purchase. Thus, if the prior item is identified in the category “golf clubs” the system will attempt to match seller items in the item available to sell database that are in the same branch of the category tree as “golf clubs.” If no items match the keyword or category, the system will randomly insert seller's items available to sell.

Once the items available to sell are identified, the create marketing emails software compiles the email for the targeted buyer by compiling pre-determined text fields and data relating to the buyer's next expected rebate percentage with the items available to sell into an email format and sends the email. The system then sends the completed email to the email address used by the buyer on the payment transfer agent system.

The items available to sell are presented in the email as active HTML links. The combination in one email of the predetermined text, the clear reminder of the next rebate reward level and the inclusion of HTML links to available items acts as a powerful marketing message to stimulate buyer response as recorded by a buyer click-thru. A buyer click-thru occurs when the buyer clicks on the item available HTML link in the email.

The create marketing emails software also contains a routine which records each buyer click thru before redirecting the buyer's browser directly to the web page for the item linked where the item can be purchased. If the item is purchased and paid for using the same buyer payment transfer agent ID, the transaction will be reviewed by the Payment Transfer Agent Account Review software as described earlier.

The loyalty system also provides the registered seller with functionality to create a custom campaign. Sellers can establish custom campaigns by segmenting opted-in buyers for each campaign. The system provides sellers with the ability to segment on recency of buyer purchase, frequency of buyer purchase or monetary value of each buyer. For instance, a seller can choose to create a custom campaign for all opted-in loyalty buyers who have purchased from the seller within the last 30 days or a separate custom campaign can be created for all buyers who have not purchased from a seller within the last 90 days. Likewise, the seller can establish custom campaigns for any opted-in loyalty buyer who has made more than three purchases from the seller or for buyers who have spent at least $500 with the seller. Segmentation can be across multiple variables so a seller can select all buyers who have made a least three purchases, with a least one within the last 30 days and who has spent at least $500 with the seller.

After segmenting the buyer base for the custom campaign, the seller next creates a custom campaign offer for the segmented buyer group. The custom campaign offer can be a percent-back or a cash-back reward. Further, the seller can establish minimum requirements to get the custom campaign reward. For instance, the seller can offer any segmented buyer a reward of 5% back or $5.00 back if the buyer spends at least $100 within 30 days of the date of the email being sent.

### BRIEF DESCRIPTION OF THE DRAWINGS

These and other features and advantages of the invention will now be described with reference to the drawings of certain preferred embodiments, which are intended to illustrate and not to limit the invention, and in which:

FIG. 1 is a high-level architectural drawing illustrating the primary components of a Customer Loyalty Reward System used by sellers to reward buyers for purchases paid through a payment transfer agent.

FIG. 2 is a block flow diagram illustrating the method in accordance with the invention.

FIG. 3 is a diagram of information for a seller account record for use with one embodiment of the present invention

FIGS. 4A-B are samples of the image HTML code as text and as it is displayed on a screen.

FIG. 5 is a sample screen shot of a widow window presented when a buyer seeks more information on the loyalty reward system after clicking a link within the image.

FIG. 6 is a sample screen display of a market venue listing page with the HTML image as it is displayed to potential buyers.

FIG. 7 is a diagram of information for a mass pay file for use with one embodiment of the present invention.

FIG. 8 is a diagram of information for a buyer account record for use with one embodiment of the present invention.

FIG. 9 is a sample buyer loyalty invitation email for use with one embodiment of the present invention.

FIG. 10 is a block flow diagram illustrating the marketing email creation method in accordance with the invention.

FIG. 11 is a sample marketing email for use with one embodiment of the present invention.

FIG. 12A-B are sample screen shots of the shopping search page forms and results.

FIG. 13 is a block flow diagram illustrating the shopping search page method in accordance with the invention.

FIG. 14 is a block flow diagram illustrating the custom campaign creation method in accordance with the invention.

FIG. 15A-C are sample screen shots of the custom campaign creation page input forms.

FIG. 16 is a sample screen shot of a seller account creation input form.

### DETAILED DESCRIPTION OF THE DRAWINGS

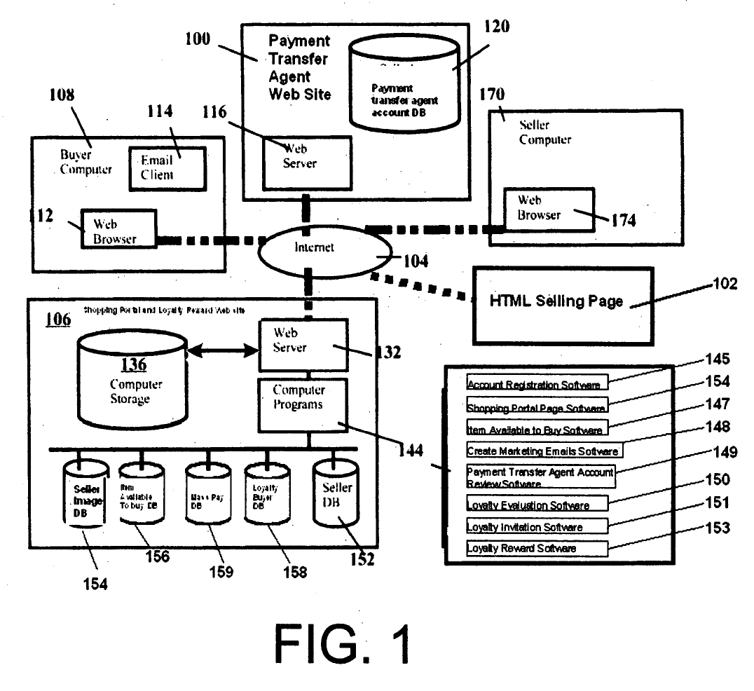

FIG. 1 is a high-level architectural drawing illustrating the primary components of a loyalty reward system used by sellers to reward buyers for purchases paid through a payment transfer agent. The loyalty reward system includes a buyer computer 108, a payment transfer agent web site 100, a seller computer 170, an HTML selling page 102 and a loyalty reward web site 106, all of which are linked together by the Internet 104. The buyer computer 108 may be any type of computing device that allows the buyer to receive and respond to emails via an email client 114 and interactively browse Web sites via a Web browser 112. For example, the buyer computer 108 may be a personal computer (PC) that runs the Windows NT operating system and Netscape Navigator and which can access the Yahoo Mail email service at Yahoo.com.

A preferred embodiment of this invention is a system and method for use with the Internet 104, a widely known global computer network. This invention is, however, not limited to the Internet. Thus, as used herein, the term “network” refers to any distributed computer network whether it be a local area network (LAN), a wide area network (WAN), or an Intranet.

The payment transfer agent web site 100 is a web site such as PayPal.com, Payments.Google.com, GreenZap.com or BidPay.com, which provide various functionality to allow buyers to pay participating sellers for items purchased from HTML selling pages or to allow two parties to transfer money between each other. Typically, the payment transfer agent web site 100 will be operated by a business entity that handles buyer and seller account creation, payment transaction processing at the close of a sale including check clearinghouse functions such as debiting and crediting accounts of two or more parties as well as credit card payment processing and includes a web server 116 and a payment transfer aggent account database 120.

The shopping portal and loyalty reward web site 106 advantageously includes a web server 132 and computer storage 136, a seller account database 152, a seller image database 154, an item available to buy database 156, a loyalty buyer database 158, a processed mass pay file database 159 and multiple computer software programs 144 (FIG. 1B)

The HTML selling page 102 is a document written in hyper-text mark-up language that can be created or read over the Internet using a web browser. In a preferred embodiment, the HTML selling page 102 promotes an item or service for sale and contains text and links within the selling page.

The seller computer 170 may be any type of computing device that allows the seller to interactively browse Web sites via a Web browser 174. For example, the seller computer 170 may be a personal computer (PC) that runs the Windows 2000 operating system running Internet Explorer.

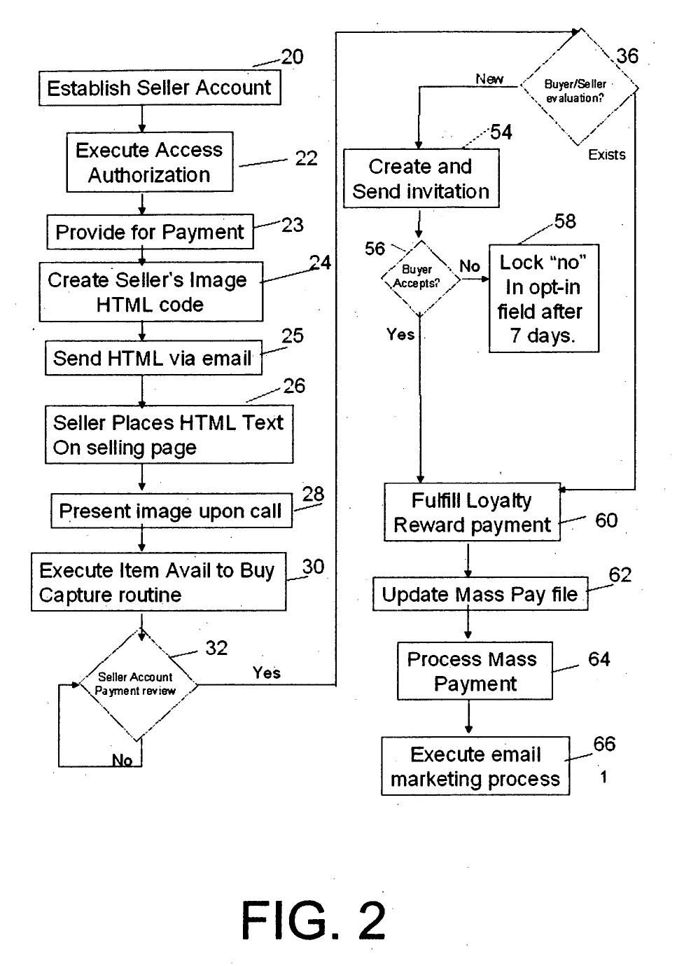

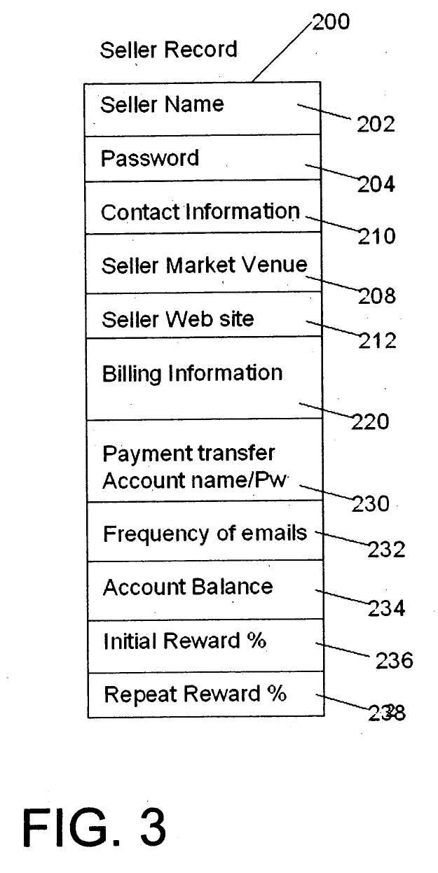

FIG. 2 is a general flow diagram of the method of this invention. Referring to this figure, establishment of a seller account is initiated at Step 20. Creation of a seller account includes the seller inputting seller account information such as name, address, billing information, selecting the frequency of opt-in emails, selecting the reward percentage to offer to buyers who opt-in to the seller's reward program, selecting the default reward percentage to apply to repeat purchase payments for opted-in buyers and entering the seller's selling venues (auction sites, web sites, store fronts, etc) into a seller unique database record housed on the loyalty system's seller database 152. FIG. 3 is a diagram of information for a seller account record for use with one embodiment of the present invention.

Each time a seller establishes an account the loyalty system executes an access authorization, step 22, to allow the seller to authorize the payment transfer agent to allow the loyalty web site 106 to automatically access the seller's payment transfer agent account 120 to retrieve buyer payment data. In a preferred embodiment of the invention, the access authorization, step 22, allows the seller to both authorize the payment transfer agent to allow the loyalty web site 106 to automatically access the seller's payment transfer agent account 120 to retrieve buyer payment data and to issue earned buyer rewards through a mass payment from the seller's account on the payment transfer agent web site 100.

In one embodiment of the invention, the access authorization, step 22, includes the providing the registering seller with step-by-step instructions on how to provide permission for the loyalty system to automatically access the seller's payment transfer agent account 120 to retrieve buyer payment data and to issue rewards from the seller's account on the payment transfer agent web site 100. In this embodiment, the seller establishes this permission at the payment transfer agent web site 100.

In a preferred embodiment, access to the seller payment transfer agent account 120 for the system is provided by the seller establishing API permission specifically for the system to use. The API permission allows the system to access the seller's account on the payment transfer agent web site 100 through a secure process. Alternatively, the seller can establish a unique access ID and password 230 which is recorded into the seller's database 152 on the loyalty reward web site 106. The unique ID and password created can be used to access at the payment transfer agent web site 100.

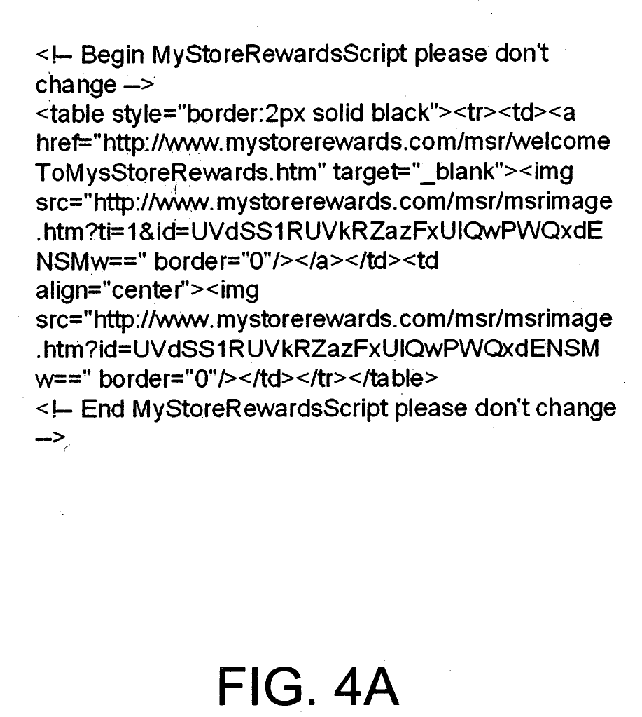

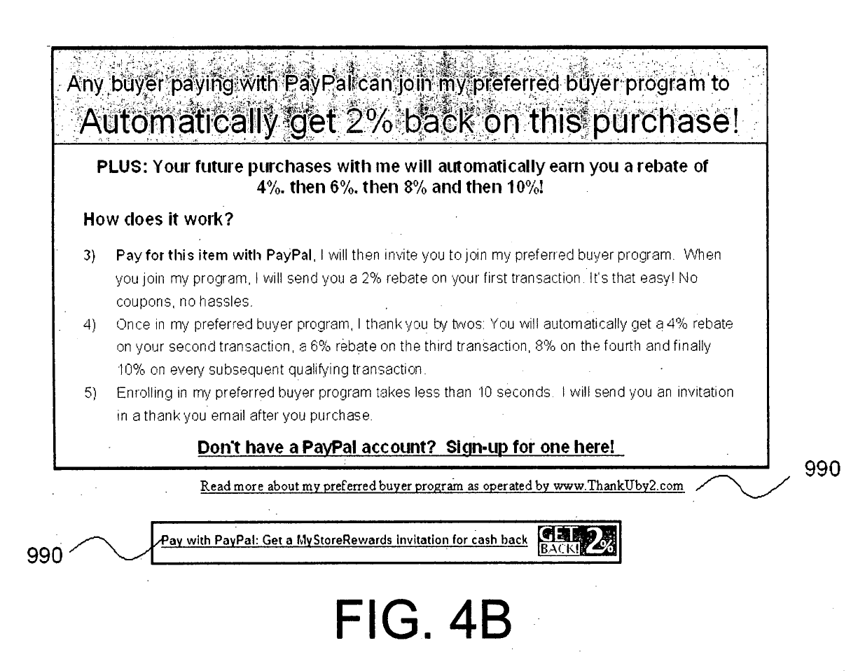

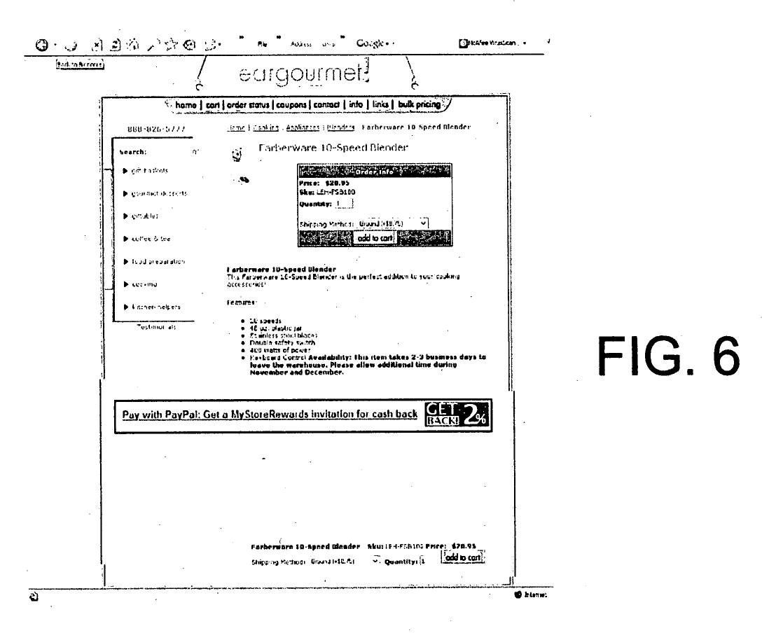

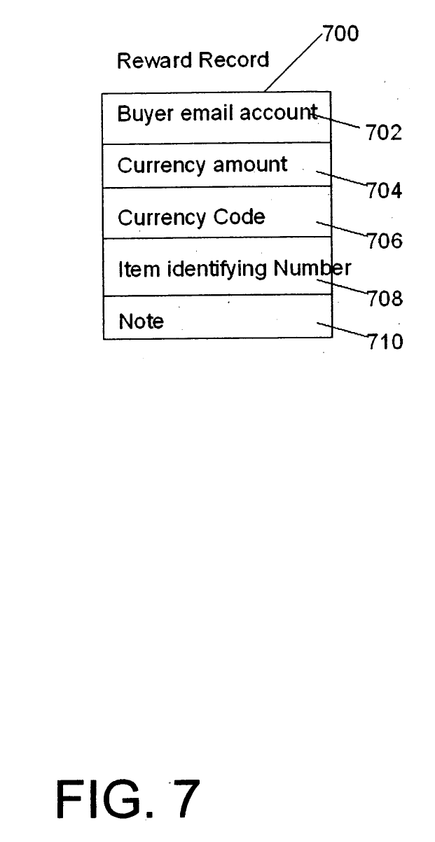

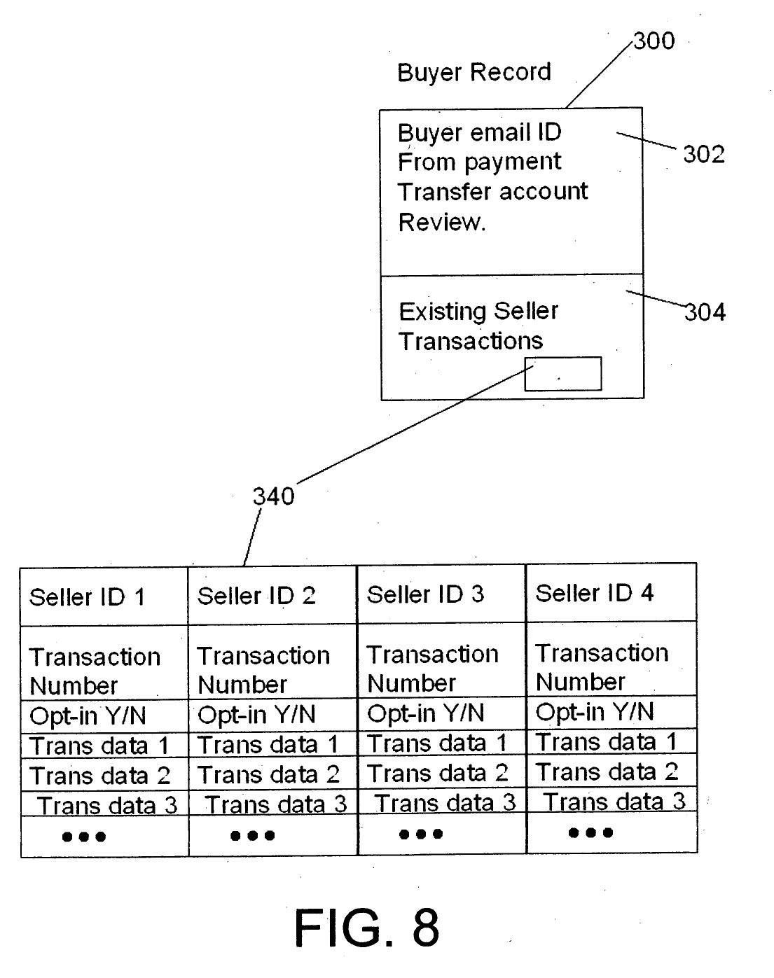

In one embodiment of the invention, during registration of a seller account, the system also provides for the seller to make a payment of a specified amount for the seller's use of the loyalty reward system. Provision for payment is made by redirecting the seller to the payment transfer agent web site 100 during seller registration, step 23. During this step, the account balance 234 is recorded in the seller's record 200 on the seller database 152. This payment establishes a positive cash account which will be subsequently debited by the loyalty system for reward fulfillment to qualified buyers. Next, at step 24, the system creates unique image HTML code for the seller. The image file is a graphic image used with the loyalty system by the seller to present the loyalty program to all potential buyers from within the seller's HTML selling page 102 at a market venue, on the seller's own ecommerce site, or within an HTML email. FIG. 4A is a sample of the HTML code and FIG. 4B is a screen display of the resulting sample image file as shown in a browser. FIG. 6 is a screen display of an HTML selling page 102 with the image included.

As shown in FIG. 4B, the image file includes text which explains the loyalty service to the buyer. The image is in the form of a JPG, GIF or PNG type graphic file which resides on the loyalty system's seller image database 154. The seller's unique image JPG or PNG type file acts to inform the potential buyer of the process required to receive specific rewards under the seller's loyalty program as administered through the loyalty system. In a preferred embodiment, the image explains that if the buyer purchases the item co-located on the HTML selling page 102 where the image is being presented (FIG. 6), and the buyer also pays for the co-located item using a specific payment transfer agent such as PayPal, GreenZap, BidPay or through a specific payment processor, the buyer will automatically receive an email invitation to join the seller's loyalty program and can receive a reward percentage back on the payment price.

This explanation of the sequence of events presented concurrently with a sale is a critical element of the invention because the image can be easily placed by the seller on any item selling web page on any ecommerce or auction web site during web page creation and the image efficiently discloses the loyalty program to the buyer with no extra hardware or software required by the seller. The image as described can be placed within any listing template or selling page on a market venue web site such as eBay.com, or on hosted store fronts, such as Yahoo Stores, or on an ecommerce site directly owned by the seller or within an HTML enabled email selling message. Placement of an image requires no additional hardware or software for the seller. The image is presented concurrent with the buyer viewing the listing with a standard web browser.

Returning to the registration process, the HTML text is made available to the seller via a link on the loyalty reward web site 106 or is sent as an attachment to an email after the successful completion of the seller's registration, step 25. Sellers can also return to the shopping portal and loyalty reward web site 106 to retrieve the seller's HTML text at any time. Alternatively, the system can automatically place the HTML into the seller's HTML selling pages 102.

The seller places the HTML text (FIG. 4A) on to any HTML selling page 102 during step 26. Alternatively, the seller can place the HTML text (FIG. 4A) on to a listing template used by the seller to create any HTML selling page 102 or the system can insert the HTML text (FIG. 4A) automatically into the HTML selling page 102.

In step 28, upon the first buyer web browser 112 directed by a buyer to the HTML selling page 102, the shopping portal and loyalty reward web site 106 provides the image from the seller image Database 154 through the system's web server 132 so the image (FIG. 4B) is presented at the place on the HTML selling page 102 chosen by the seller (FIG. 6). A graphic file is superior to simple text because it is substantially more difficult to tamper with the loyalty reward program disclosures presented within the image file than to tamper with an explanation in a pure text file. Moreover, since the graphic image file resides on the loyalty reward web site 106, any required update or suspension of the seller's loyalty program can occur with one simple change.

In a preferred embodiment of the system, the presented image relays instructions and a promise to the buyer by stating that if the buyer makes a payment for the item with the payment transfer agent associated with the loyalty system, the buyer will receive an email invitation to join the seller's preferred buyer program. If the buyer accepts the loyalty program invitation delivered via an email, the buyer will receive an rebate reward and buyer's acceptance also enrolls the buyer in the seller's loyalty program as administered by the system.

Furthermore, in one embodiment of the system, the image can relays information disclosing that enrollment ensures subsequent purchase payments from the buyer using the same buyer payment transfer account will result in additional rewards to the buyer. In one embodiment, the rewards are progressive such that each next transaction provides a higher level of rewards. However, sellers may choose to set any reward percentage they wish for the initial opt-in reward or the subsequent transaction reward.

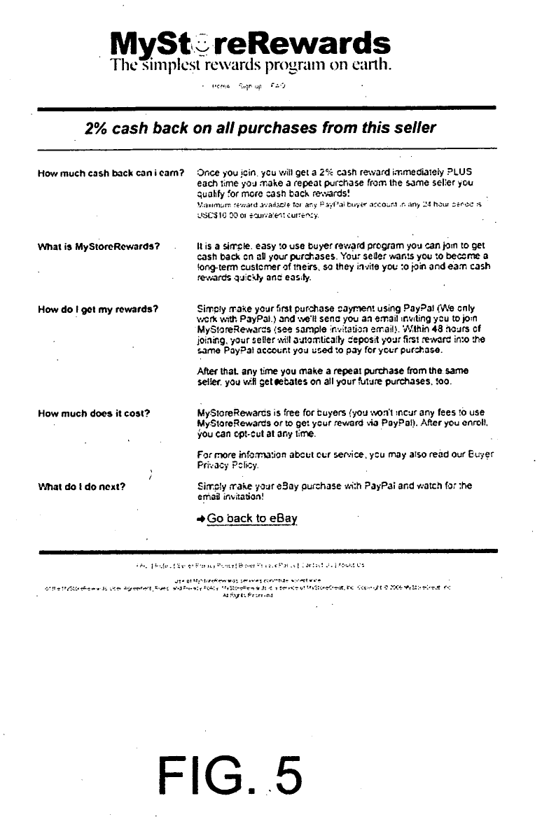

Included with the image presented to the buyer on the collocated item selling page is an HTML link (FIG. 4B 990). The potential buyer can click on this HTML link prior to purchasing the collocated item. When clicked on, the link opens a window within the buyer's browser. The window will display a web page called from the loyalty system's web server. FIG. 5 is a sample screen shot of this window. This page explains in more detail how the seller's loyalty program operates and is presented by the loyalty reward web site 106. In this way, potential buyers have access to the full disclosure of all aspects of the loyalty system's rules and operation prior to purchase.

At step 30, the system next executes the item available to buy software 147 to capture vital item selling information from the HTML selling page 102 using the web page URL address as captured during the previous step's browser call. Captured information from the listing includes the item title, unique item identification number, price point for the item, shipping charges for the item, and any other pertinent information required. The system captures this information and places it into an item available to buy database 156 within the loyalty reward web site 106. Alternatively, the system can capture the item available to buy data through API calls to a market venue or through a file upload by the seller, through a standard web crawling process or through an RSS feed from the seller. Upon capturing this data, the system holds enough information to recognize a seller has chosen to offer the loyalty program to buyers concurrent with a specific item being sold by the seller at a specific web location and the system holds relevant data for that particular item.

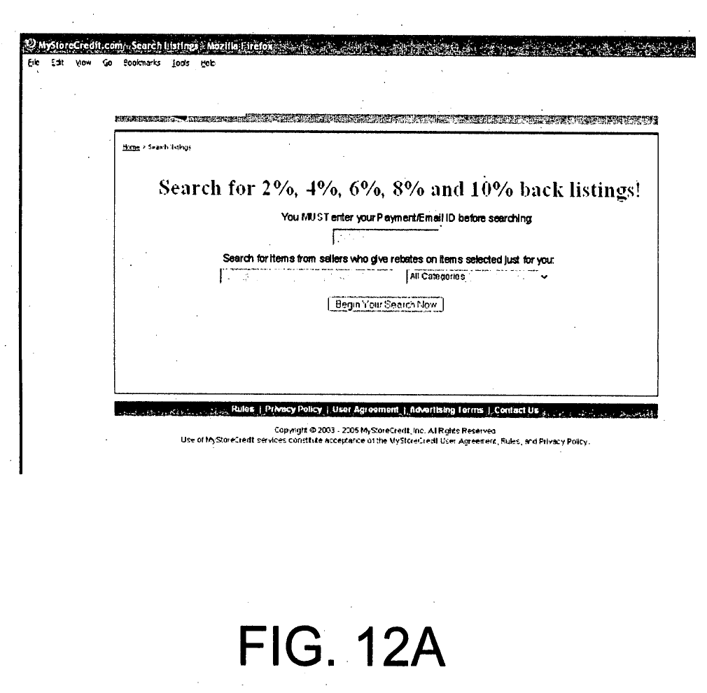

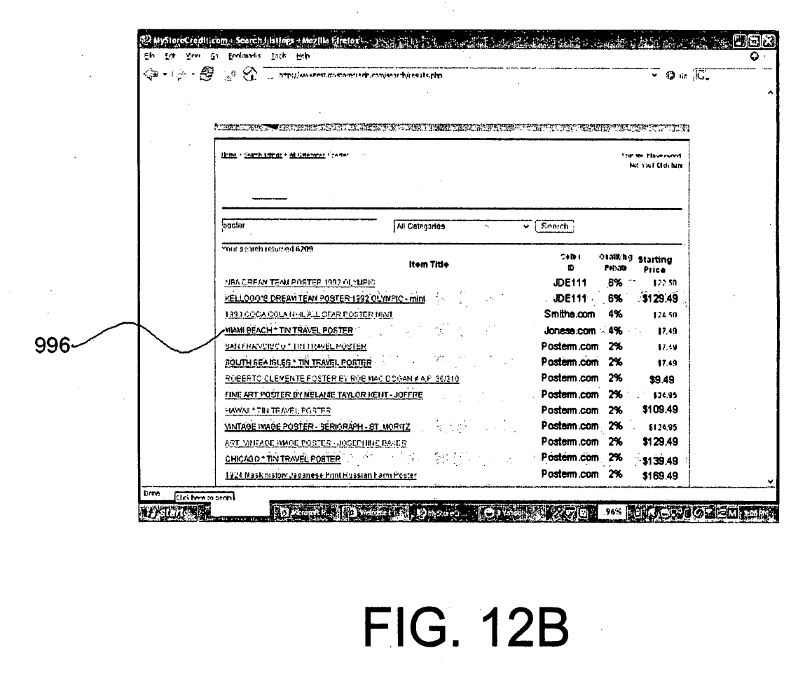

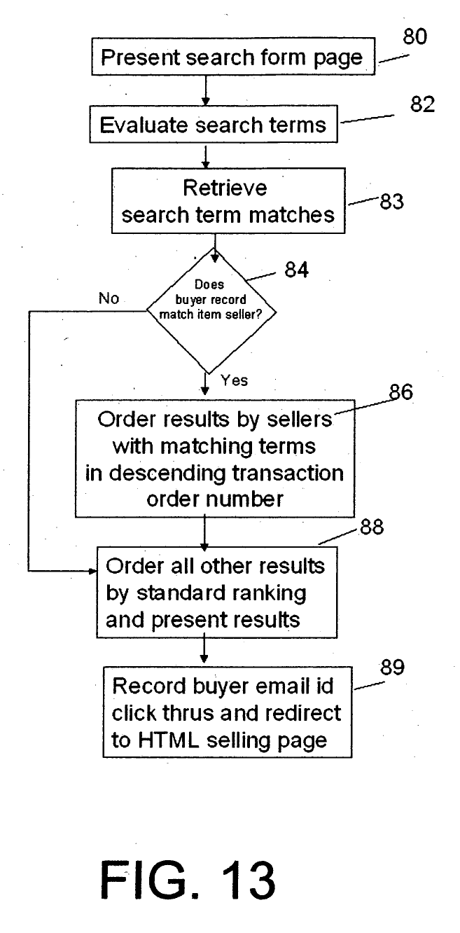

Once the item available to buy information is captured, the system provides for the presentation of the item available to buy information on a shopping portal page FIG. 12A-B. The shopping portal page process is outlined in the process flow diagram in FIG. 13.

Referring to step 80, the system presents any buyer using a web browser 112 with a forms for searching on a shopping portal page. FIG. 12A shows one embodiment of the portal shopping page for presentation through the buyer web browser 112. Referring to FIG. 12A, the buyer is invited to enter in his/her email address as used on the payment transfer agent web site 106 along with at least one search term and/or one category term to initiate a search.

At step 82, the shopping portal page software 153, sends a database query using the search terms to the item's available to buyer database 156 to capture all items matching the buyer's entered search terms and/or category. The captured results of the query will include the information for each record from the item available to sell database 156 including the title of the item and the seller offering the item.

Next, at step 84, the shopping portal page software 153 evaluates the buyer record for the buyer email id entered to see if the buyer record includes any seller ID 340 that matches the seller ID for the captured results. If no, the system moves to step 88 and all captured results are displayed by a standard ranking. In a preferred embodiment, the standard ranking is in descending order of item price. Alternatively, the ranking can be alphabetical or random or any other such standard ranking.

If, at step 84, the shopping portal page software 153 finds a yes match to a seller ID 340 that is both in the buyer record 300 and in the items available to buy database 158 for the captured items, the system moves to step 86. At step 86, all matching seller item results are rank-ordered in descending order by the rebate percentage being offered to the identified buyer. Thus, the seller offering the greatest reward percentage to the buyer is shown first. If multiple sellers exist at the same rebate percentage level, the system can rank them according to a random placement. After all matching search term items have been ranked, the search results are presented to the buyer.

FIG. 12B demonstrates a buyer search result showing items with the highest ranking seller presented superior to other seller items. The links, 996, as presented in FIG. 12B, are active HTML links which represent the URL address of the item being sold. The combination in a shopping search results of the item sought along with the promise of a rebate reward first from prior sellers then from any seller, along with the inclusion of HTML links in the search results, such links associated with the available items for sale, acts as a powerful marketing message to stimulate buyer click-thru. A buyer click-thru occurs when the buyer clicks on the item available HTML link on the search results page (FIG. 12B).

The shopping portal page software 153 also contains a routine which records each buyer click thru before redirecting the buyer's browser directly to the HTML selling page 102 associated with the item linked, step 89. If the item is paid for using the loyalty system's payment transfer agent web site 100, the transaction will follow from step 32, in FIG. 2. In step 32, the loyalty system executes a seller's payment transfer agent account review. The payment transfer agent account review software 149 reviews the seller's payment transfer agent account 120 on the payment transfer agent web site 100, at a specific time interval. Alternatively, the payment transfer agent web site 100 can send notifications to the loyalty reward system 106 whenever a sales payment transaction occurs. In a preferred embodiment, the payment transfer agent account review software 149 accesses the seller data on the payment transfer agent web site 100 using the appropriate payment transfer agent's automated program interface (API) calls. API permission is granted by the seller to the system during the seller registration process.

Alternatively, the system can uses the unique ID and password 230 registered during the seller's account creation (step 20) to access the payment transfer agent web site 100 to access the seller payment transfer agent account 120. In either case, the payment transfer agent account review software 149 captures seller transactions that are newly paid for by a buyer since the prior review. The time interval the software reviews the seller's payment transfer agent account can be anywhere from 1 second to any number of days.

During the seller's payment transfer agent account review, step 32, if the system recognizes no new payment transactions, it returns and waits for the next periodic review. If the system recognizes a new payment transaction has occurred since the last review the payment transfer agent review software will execute the buyer/seller evaluation, step 36. In step 36, the loyalty system executes the loyalty invitation software 151 to process the new transaction for loyalty program relevancy.

This loyalty invitation software 151 identifies the buyer ID in the newly captured payment transaction for the seller account and determines if the buyer ID 302 exists in the loyalty buyer database 158. In a preferred embodiment, the buyer ID is a unique email address and each loyalty buyer record 300 includes seller IDs 304 identifying the seller's whom the buyer has made prior payments.

If the system recognizes the buyer ID as already existing in the loyalty buyer database 158 and recognizes the buyer is already associated with the seller in the transaction being analyzed on the loyalty system, the system moves to increment the transaction number 340 for the seller ID by one and then the system moves to capture relevant transaction information for the transaction and append it to the seller ID. Relevant transaction information includes the total payment amount and can also include the date and time of payment to the payment transfer agent, web site venue of the transaction, item titles purchased in the transaction, etc. Next the system moves to step 60.

If the system finds the buyer ID 302 but does not find the seller ID 340 within the buyer record, the loyalty invitation software 151 identifies the transaction as new and moves to creating a new seller transaction record 340 in the existing buyer account 300 by entering the seller ID and setting “one” for the associated transaction number and then the system moves to capture relevant transaction information for the transaction and append it to the seller ID. Relevant transaction information includes the total payment amount and can include the date and time of payment to the payment transfer agent, web site venue of the transaction, item titles purchased in the transaction, etc.

If the buyer ID does not exist at all on the loyalty buyer database 158, the system identifies the transaction as new and moves to create a new buyer record 300 by entering the new buyer ID 302 and updating the first seller ID field 304 with the unique seller ID 340 and setting the associated transaction number to one and then the system moves to capture relevant traction information for the transaction and append it to the seller ID. Relevant transaction information includes the total payment amount and can include the date and time of payment to the payment transfer agent, web site venue of the transaction, item titles purchased in the transaction, etc.

For new identified records, the system next moves to continue processing the new buyer/seller transaction by creating and sending a loyalty email invitation, step 54. At this step, the loyalty invitation software 151 moves to create and send an email for the newly updated buyer account. The email offers the buyer enrollment into the unique seller's loyalty program.

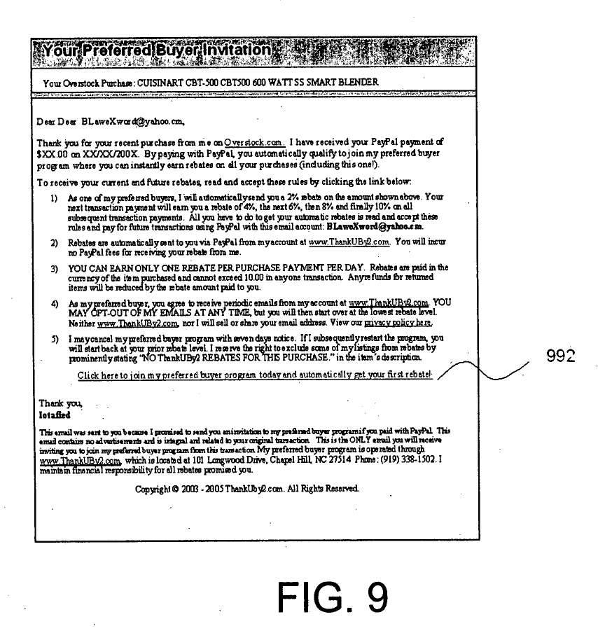

To create this invitation email, the loyalty system gathers specific pre-formatted text and combines the text with information for the targeted buyer from the buyer's record 302 on the loyalty buyer database 158. The preformatted text is retrieved from the computer storage 136 and is preferably text describing to the recipient the purpose of the email, lists of specific rules that the recipient must read and agree to for acceptance into the seller's loyalty program. The email also includes an HTML link for the recipient to acknowledge agreement (FIG. 9, 992). FIG. 9 is a sample invitation email. The system composes these elements into one email and sends the email to the buyer's email address.

In a preferred embodiment of the invention, the rebate reward offered to the buyer within both the HTML image (FIG. 4B) and subsequently in the invitation email (FIG. 9) is a percentage rebate of the amount paid, which may alternatively include or exclude shipping and handling fees.

At step 56, the system next waits to receive confirmation of a buyer's acceptance to the invitation email. Upon receipt, a buyer can open and read the invitation email (FIG. 9) and can accept the loyalty invitation offer by clicking the link (FIG. 9, 992) to acknowledge agreement to the rules and acceptance of the loyalty invitation. If the link is clicked, the system records the buyer's acceptance into the program based on an internet call message sent by the buyer's browser after the click. The loyalty invitation software 151 records the receipt of the message by setting the opt-in field 340 for the seller/buyer transaction to yes and the system next moves to step 60.

The initial seller/buyer opt-in field 340 is created with a “No” flag. If a buyer chooses to ignore the email or does not click the invitation confirmation link (FIG. 9, 992), within a certain period of days, the no is locked for the opt-in field 340 for the buyer account on the loyalty record database 156, step 58. Thus, the buyer has a set time period to positively accept the invitation by clicking the link. In a preferred embodiment of the invention, the invitation is available for buyer acceptance for 7 days from the date and time emailed.

Alternatively, the link (FIG. 9, 992) in the email can open a widow web page presenting a form for the buyer to complete to confirm his/her acceptance of the rules. In either situation, the system records the buyer's agreement by updating the buyer's record in the loyalty buyer database.

Once the buyer's acceptance and opt-in is recorded, the system moves to fulfill the buyer loyalty reward, step 60. The system's loyalty reward software 153 is initiated and executed for the eligible buyer account. The loyalty reward software 153 evaluates the payment amount paid by the newly registered transaction 340 on the loyalty buyer database 158 and calculates a specific percentage rebate or currency figure for the price paid amount. In a preferred embodiment of the invention, the rebate reward percentage used for the first paid transaction of a loyalty buyer as recorded at the payment transfer agent is uniquely set by each seller during registration, or as updated by the seller thereafter, as a precentage of the payment made or can alternatively be a precent of a single item price paid and may or may not include shipping and handling fees for the item(s). The loyalty reward software can also cap any reward rebate for any transaction to a specific currency unit such as USD$10.00. The loyalty reward software 153 will record the reward amount in the same currency as the original transaction.

Next, at step 62, the loyalty reward software routine will record relevant data about the buyer's rebate reward into a transaction specific record in an open mass pay file for the seller on the mass pay database 158.

The unique seller's open mass pay file holds transaction specific records for rewards due from the seller's buyers. In a preferred embodiment of the invention, the mass pay file is a text file which has fields delineated by tabs. Fields recorded for each transaction include the buyer's payment transfer agent email address, the amount of rebate reward due that buyer, plus a character description of the currency for the rebate reward, a transaction identifier number and a text note field.

The loyalty reward software 153 will continue to add individual transaction reward records to the mass pay file for each seller at a specified date and time, such as once per day at 12:00 am GMT. At that time, Step 64, the loyalty reward software 153 will process the mass pay file. The process includes opening a new mass pay file and closing the existing mass pay file. The loyalty reward software 153 will maintain a copy of the closed mass pay file within the mass pay database 159 and will then send the mass pay file to the payment transfer agent using approved methods dictated by the payment transfer agent. In a preferred embodiment, the system will upload the mass pay file to the payment transfer agent using the payment transfer agent's appropriate API calls. Upon confirmation that the mass pay file was received from the payment transfer payment agent, the mass pay software 153 will update the seller's database file 200 and the buyer's database file 300 with notations of the time date and amount of the reward payment.

In one embodiment of the invention, the system will send each seller an email some number of hours prior to issuing the mass payment file to the payment transfer agent web site 100. The email will provide the seller with details on all pending rewards which will be issued within a set number of hours, such as 48, along with a link to immediately stop payment on the mass payment file or which links to a web form allowing the seller to stop payment on any pending individual buyer reward.

In an alternative embodiment, the system creates one single mass payment file for all sellers and issues the mass payment file from a payment transfer agent account associated with the system.

During execution of the buyer/seller evaluation, step 36, if the system recognizes a payment from a prior buyer has occurred for the seller account being monitored, the system will move to directly execute loyalty reward payment, step 60. The loyalty reward software routine evaluates the payment made by the prior loyalty buyer and calculates a specific percentage for repeat sales as recorded during the seller registration or subsequently updated by the seller after registration or a dollar figure for the payment amount based on the sequence of the purchase.

In one embodiment of the invention, the rebate reward percentage calculated for the second transaction between the same buyer and seller as recorded in the loyalty buyer database 158 will be 4%, the third transaction will be 6%, the fourth will be 8% and all subsequent qualifying purchases will be for 10%. The transaction number field 340 for the buyer/seller combination dictates the percentage applied to the transaction. The loyalty reward software 153 can also cap any reward rebate for any transaction to a specific currency unit such as 10.00. Moreover, the rebate percentage can be calculated on payment made, item price paid or can alternatively be on the item price paid plus shipping and handling paid. The system continues by updating the mass pay file at step 62.

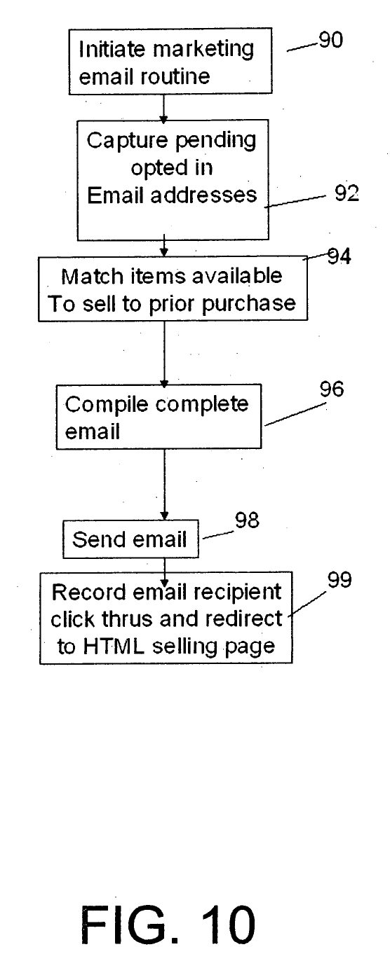

The system periodically creates marketing emails that are sent to opted-in buyers. Step 66 identifies this step. Step 66 is further described by the diagram on FIG. 10.

Referring to step 90 in FIG. 10, on a periodic basis, such as once per day, the loyalty reward system initiates an outbound email creation routine. After initiation, the create marketing emails software 148 captures buyer email addresses for opted-in buyers due a marketing email, step 92.

In a preferred embodiment, the seller pre-determines the frequency of emails to be sent to any opted-in buyer during the seller registration process, FIG. 2, step 20. For example, sellers can choose to have any opted-in buyer receive emails every 15, 30 or 45 days. Opt-in permission for a buyer is recorded when a buyer accepts the rules by clicking the link presented in the loyalty invitation email (FIG. 6, 992). By accepting the invitation to the loyalty program, the buyer is also providing opt-in permission to receive marketing emails from the seller's account on the loyalty system. The marketing email software 148 determines the email schedule for each buyer to match the selected frequency of the seller's selection at registration as recorded in the seller's record 200, in field 232, on the seller database 158. Thus, a seller choosing 30-days for email frequency during registration establishes that each opted-in buyer will receive emails once per month for 12 months. Thus, when the create marketing email software 148 executes, it will capture and prepare the information needed to execute buyer outbound marketing emails just for buyer email addresses due for an outbound email from an associated seller in the upcoming period.

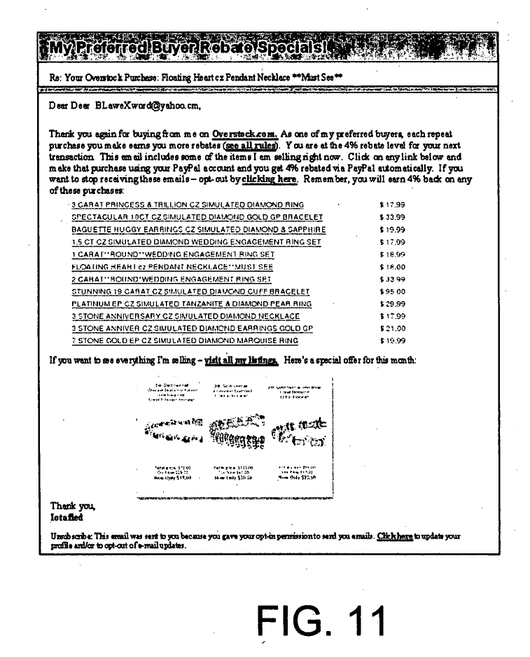

FIG. 11 shows a sample outbound marketing email. To prepare the buyer's outbound email, the create marketing emails software 148 will gather matches from the seller's current items available to sell within the items available to sell database 156 to the prior item or items purchased by the buyer. The create marketing emails software 148 attempts to match items available to sell records for the targeted buyer's seller within the items available to buy database 156 based on a key word and/or category match. For instance, if the buyer has a prior purchase of a Golf club, the software will attempt to match seller items in the item available to sell database that have the words “golf” or “club”. In addition, the system will evaluate any category identifier for the prior purchase. Thus, if the prior item is identified in the category “golf clubs” the system will attempt to match seller items in the item available to sell database that are in the same branch of the category tree as “golf clubs.” If no items match the keyword or category, the system will randomly insert seller's items available to sell. The matching and selection process is reflected in step 94.

Alternatively, the system can dynamically search a seller's items available to sell by visiting the seller's ecommerce web site or placing a call to capture the seller's items available to sell at a market venue such as eBay.com

In step 96, once the appropriate seller's items available to sell are identified, the create marketing emails software 148 compiles the email for the targeted buyer by compiling pre-determined text fields and data relating to the buyer's next expected rebate percentage with the items available to sell into an email. At step 98 the create marketing emails software 148 sends the compiled email to the buyer email address.

The items available to sell are presented in the email as active HTML links as shown in FIG. 11. The combination in a single email of the predetermined text, the clear reminder of the next rebate reward level and the inclusion of HTML links to available items for sale acts as a powerful marketing message to stimulate buyer click-thru. A buyer click-thru occurs when the buyer clicks on the item available HTML link in the email.

The create marketing emails software 148 also contains a routine which records each buyer click thru before redirecting the buyer's browser directly to the HTML selling page 102 associated with the item linked, step 99. If the item is paid for using the loyalty system's payment transfer agent web site 100, the transaction will follow from step 32, in FIG. 2.

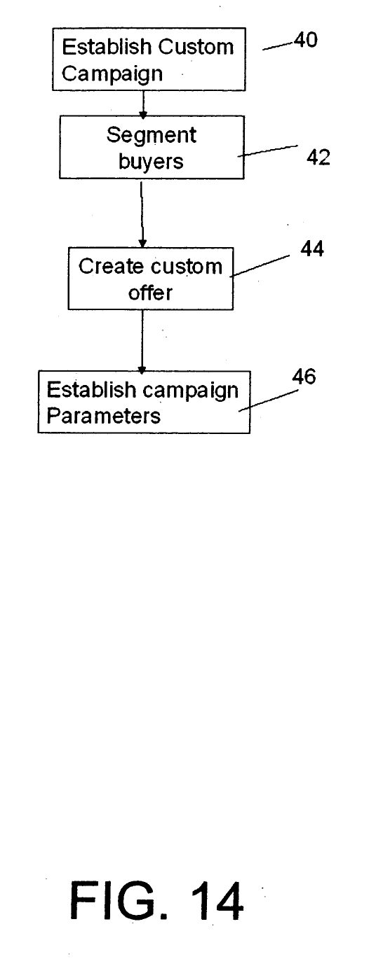

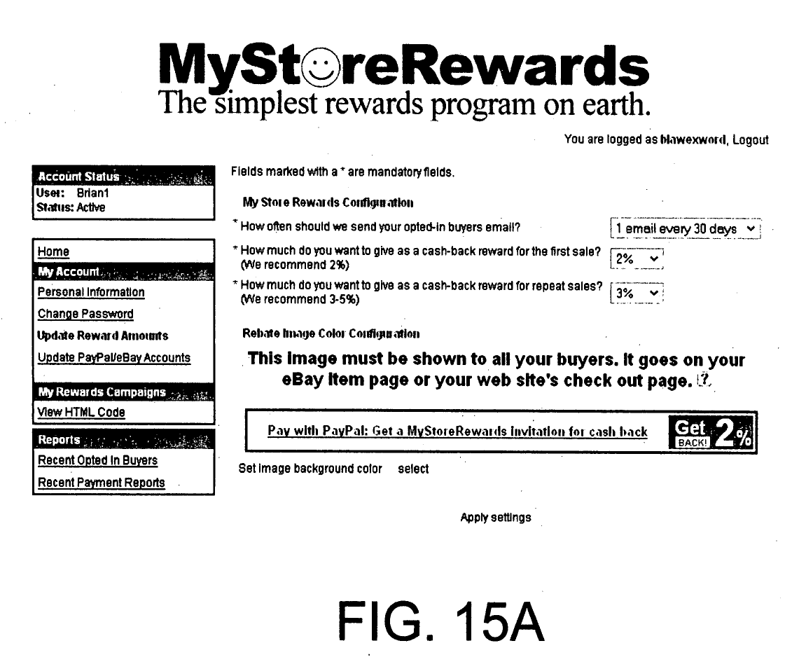

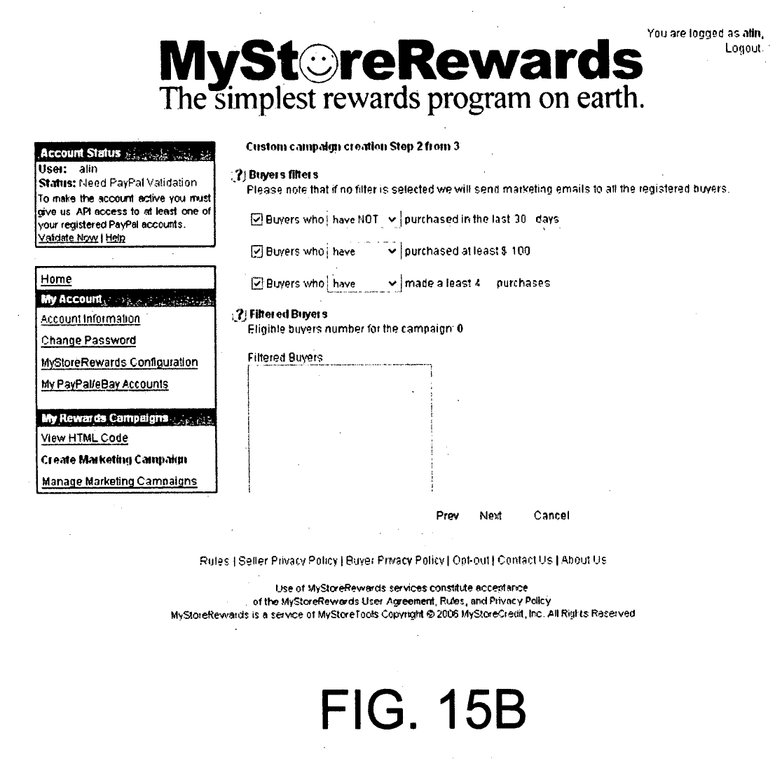

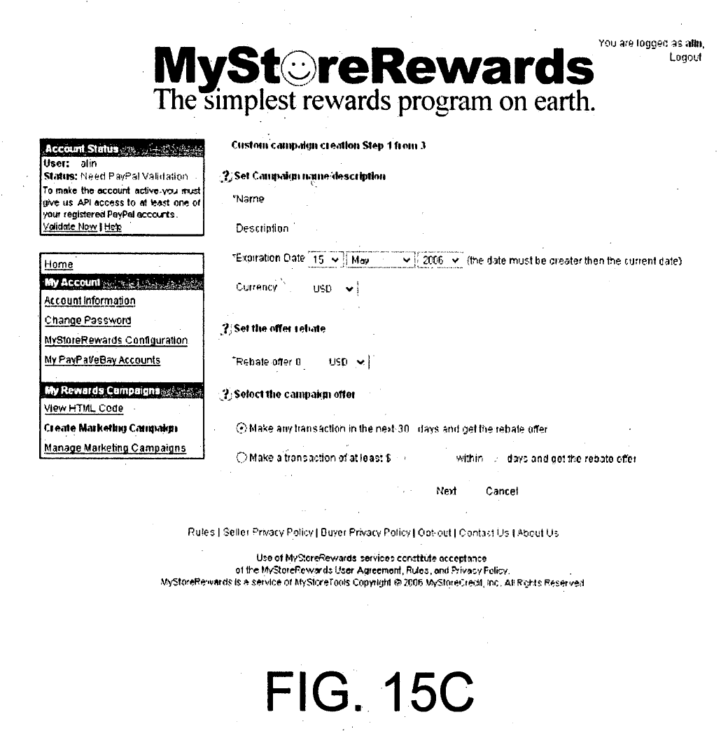

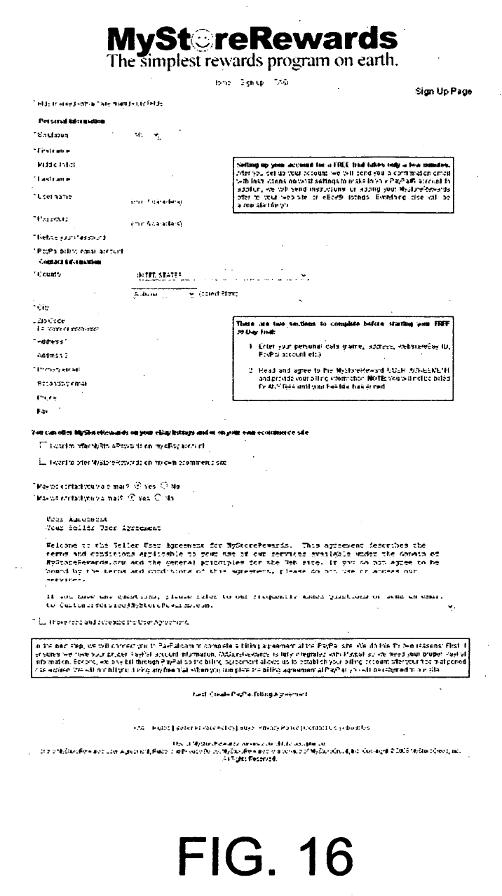

The loyalty system also provides the registered seller with functionality to create a custom campaign. The process of establishing customer campaigns is shown in FIG. 14 as a block flow diagram illustrating the custom campaign creation steps. Referring to step 40, sellers can establish custom campaigns by returning to the loyalty web site 106 and opening the pages to “Custom Campaigns.” FIG. 15A-C are sample screen shots of the custom campaign creation page input forms. In step 42, the seller segments the seller's opted-in buyers for the pending custom campaign. The system provides sellers with the ability to segment on recency of buyer purchase, frequency of buyer purchase or monetary value of each buyer. For instance, a seller can choose to create a custom campaign for all opted-in loyalty buyers who have purchased from the seller within the last 30 days or a separate custom campaign can be created for all buyers who have not purchased from a seller within the last 90 days. Likewise, the seller can establish custom campaigns for any opted-in loyalty buyer who has made more than three purchases from the seller or for buyers who have spent at least $500 with the seller. Segmentation can be across multiple variables so a seller can select all buyers who have made a least three purchases, with a least one within the last 30 days and who has spent at least $500 with the seller.

In step 44, FIG. 14, the seller next creates a custom campaign offer for the segmented buyer group (FIG. 15B). The custom campaign offer can be a percent-back or a cash-back reward. In step 46, the seller can establish minimum requirements to get the custom campaign reward. For instance, the seller can offer any segmented buyer a reward of 5% back or $5.00 back if the buyer spends at least $100 within 30 days of the date of the email being sent. At the end of the custom campaign, a new campaign is created which allows a seller to offer unique buyer rewards to similar buyers. During the email creation campaign, the loyalty system will first verify if a buyer is segmented into an existing custom campaign. If so, the create marketing email software 148 will create the email identifying the special reward offer for the buyer in lieu of the default percentage back email offer. If the buyer does not fall into any custom campaign, the system issues the default email.

It will be appreciated by those skilled in the art that numerous modifications and variations are possible, and that the invention may be practiced otherwise than as specifically described herein, without departing from the scope thereof.

I claim:

1. A loyalty reward system comprising plural computers connected via a network, said loyalty reward system further comprising:
(a) means for presenting a loyalty reward offer to a buyer computer on a selling web page;
(b) means for retrieving buyer payment information comprising a buyer email address from a payment transfer agent;
(c) means for sending a loyalty invitation email to said buyer email address;
(d) means for processing a notification of buyer acceptance of said loyalty invitation email; and
(e) means for calculating a rebate reward

2. The loyalty reward system of claim 1, utilizing said buyer email address for:
(a) recording said rebate reward for said buyer email address in a mass pay file; and
(b) sending said mass pay file to said payment transfer agent for processing.

3. The loyalty reward system of claim 1, further comprising:
means for sending at least one marketing email message to said buyer email address.

4. The loyalty reward system of claim 1, wherein:
said means for calculating said rebate reward is configured to calculate said rebate reward based on a progressively greater percentage of a sale amount for each of a plurality of successive payment transactions.

5. The loyalty reward system of claim 4, further comprising:
a shopping search page presented to said buyer computer via said network and configured to rank search results in descending order of said percentage.

6. An automated method, performed by a computer-based loyalty reward system, for offering a rebate reward from a seller to a buyer as part of a transaction utilizing a payment transfer agent, the method comprising the steps of:
presenting an offer of said rebate reward on an HTML selling page;
retrieving payment information from said payment transfer agent;
sending an invitation email to a buyer email address included in said payment information,
processing an acceptance message from said buyer; and
calculating said rebate reward.

7. The method of claim 6, further comprising the steps of:
recording said rebate reward in a mass pay file; and
sending said mass pay file to said payment transfer agent for processing.

8. The method of claim 6, further comprising the step of:
sending at least one marketing email message to said buyer email address.

9. The method of claim 6, wherein:
said rebate reward is calculated as a progressively greater percentage of a sale amount for each of a plurality of successive payment transactions.

10. The method of claim 9, wherein:
items available to buy are presented to said buyer so that said items are ranked in descending order of said percentage.
